(19) United States
(12) Patent Application Publication
(10) Pub. No.: US 2003/0085581 A1
(43) Pub. Date: May 8, 2003

(54) Device for hygienically collecting and disposing of canine and feline waste

(76) Inventor: Thomas R. Jemison, Littleton, CO (US)

Correspondence Address: The Law Office of Craig W. Barber, PO Box 16220, Golden, CO, 80402-6004, US

(21) Appl. No.: 10/273,475

(22) Filed: Oct. 18, 2002

Related U.S. Application Data
(60) Provisional application No. 60/335,965, filed on Oct. 18, 2001.

(51) Int. Cl. A01K 29/00; E01H 1/12

(52) U.S. Cl. 294/1.4

(57) ABSTRACT

A device and method for collecting and disposing of animal waste is disclosed. The device includes a handle having an elongated shape and a loop that is joined to the handle at an oblique angle. The loop has a base and sides that generally define a trapezoid having rounded comers. A bag is removably attached to the loop. The bag is flexible and has an open end and a closed end. Commonly received bags which may be used are newspaper bags and grocery bags, despite the great size variation therebetween. When installed the bag passes through an interior portion of the loop and is folded over an exterior portion of the loop so that an edge of the bag located adjacent its open end extends partway towards the closed end of the bag. The device includes a first clip that is attached to the handle for securing a smaller sized bag to the front of the pole. The device includes a second clip securing a gather of “excess bag” to the rear of the pole when using a larger size of plastic/poly bag.

In embodiments, the device may further include a knife edge, straight or serrated, on the flexible band across the bottom, thus allowing a cutting or cleaving of pet waste from the surface on which it rests. In embodiments, the device may further include plastic prongs downwards to the flexible band, providing easier manufacture and greater flexibility. In embodiments, the device may further include a “size rating” based upon the sizes of bags commonly received in the area of sale. Such size rating may be based upon physical bag dimensions, source of the bag (a given newspaper or store) or other methods.

### CROSS REFERENCE TO RELATED APPLICATION

This device claims the benefit of provisional application No. 60/335,965 filed in the United States Patent and Trademark Office on Oct. 18th, 2001 and entitled DEVICE AND METHOD FOR HYGIENICALLY COLLECTING AND DISPOSING OF CANINE AND FELINE WASTE, in the name of the same inventor, Thomas R. Jemison.

### FIELD OF THE INVENTION

The present invention relates generally to handling devices and relates specifically to hygienically and sanitarily collecting and disposing of animal waste, particularly using pole mounted devices.

### BACKGROUND OF THE INVENTION

Efficient collection and removal of canine and feline waste is a growing problem for both public and private areas frequented by dogs, cats, and people. Many municipalities have enacted regulations that require pet owners to remove waste generated by their pets in public areas. Removal and disposal of animal waste is unpleasant and can be unhygienic, whether it occurs in the private residential context or in public places.

Although various devices have been proposed for collecting animal waste from the ground, many have disadvantages that limit their usefulness. For example, some of the devices are too complicated or require the use of multiple tools. Other devices require that the user stoop or bend to collect the waste or require that pet owners handle the waste with gloves. The following table provides some examples known to the applicant.

| PATENT NUMBER | ISSUE DATE | TITLE |
|---|---|---|
| 6,386,606 | May 14, 2002 | FRAME FOR CATCHING . . . |
| 6,279,975 | Aug. 28, 2001 | IMPLEMENT AND . . . |
| 6,123,046 | Sep. 26, 2000 | DEVICE FOR . . . |
| 6,076,717 | Jun. 20, 2000 | PET REFUSE BAG . . . |
| 6,068,311 | May 30, 2000 | SANITARY PICKUP . . . |
| 5,131,704 | Jul. 21, 1992 | APPARATUS FOR . . . |
| 4,958,871 | Sep. 25, 1990 | HAND TOOL FOR . . . |
| 4,962,956 | Oct. 16, 1990 | WASTE COLLECTION . . . |
| 4,705,310 | Nov. 10, 1987 | WASTE COLLECTION . . . |
| 4,457,549 | Jul. 3, 1984 | BAG MOUTH HOLDER |
| D263,512 | Mar. 23, 1982 | LITTER SCOOP AND . . . |
| 4,257,635 | Mar. 24, 1981 | SCOOP DEVICE |
| 4,191,414 | Mar. 4, 1980 | SANITARY DEVICE |
| 4,159,139 | Jun. 26, 1979 | DEVICE FOR HOLDING . . . |
| 4,146,259 | Mar. 27, 1979 | BAG HOLDER AND . . . |
| 4,103,953 | Aug. 1, 1978 | PORTABLE ANIMAL . . . |
| 4,047,746 | Sep. 13, 1977 | ANIMAL WASTE . . . |
| 4,023,842 | May 17, 1977 | PORTABLE BAG . . . |
| 4,021,994 | May 10, 1977 | SCOOP DEVICE |
| 4,012,067 | Mar. 15, 1977 | REFUSE COLLECTION . . . |

A number of these patents disclose some form long handle with a loop of some type at the end: the '606 patent, the '046 patent, the '311 patent, while others disclose using the loop to hold open a disposable bag of one size ('606, '975, '046, etc). A few have the loop set at an oblique angle to the handle ( for example the '704 patent), a triangular loop (i.e. '310), a flexible metal band ('635), or plastic and metal construction ('259). There are also a few examples of different items such as the '717, '139, and '842 patents.

There are certain problems common to all of these prior art designs.

Firstly, these designs do not greatly ease the frictional forces between the ground or other surface upon which animal waste may repose and the animal waste. Since pet waste is sometimes found on grassy or fibrous surfaces, it may have some degree of connection thereto. It would be desirable if the devices might provide some actual cleaving action to separate the animal waste from the underlying surface.

Secondly, it would be desirable to provide a construction for such a pole mounted sanitary handler for pet droppings which is simpler, cheaper, and in particular more flexible than prior art designs. Round designs are suited for certain types of simpler gathering, triangular designs provided a broad flat ground contact portion but only a narrow height, five sided designs may be considered overly complex to manufacture and sell, and other known prior art shapes have other disadvantages.

Thirdly, it would be desirable to provide a construction for such pole mounted sanitary handler having an optimum shape allowing the device to be used for relatively straightforward scooping, for cleaving, or even for simple digging at pet droppings which may be entangled in plant growth or mixed into snow or ice.

Fourthly, it would be desirable if flexible recycling of common types of plastic bags was enabled by the invention. In particular, while certain prior art devices seem well adapted to using a single size of prior art bag (such as the '310 patent, which features a single clip to hold the bag onto the device), it would be advantageous if the device could be used with several different sizes or a range of sizes of commonly acquired plastic bags. It would further be advantageous if users could determine before purchasing the product whether they could reliably use the product with the size of plastic bag they commonly encounter.

The present invention helps overcome or at least reduce the effects of one or more of the problems set forth above.

### SUMMARY OF THE INVENTION

General Summary

The present invention provides a device that allows a pet owner to collect and to dispose of animal waste without having to bend, stoop, or handle the waste material. The device has no moving parts and is therefore simple to operate. It may be used in public and private areas alike, and does not require the use of multiple tools. Because of its unique design, the device may be used to collect waste materials from multiple areas and requires minimal or no cleaning following use. The design may allow efficient cutting or scraping of materials such as grass or waste, and is of a simple and inexpensive construction. The device may be of a shape allowing very efficient gathering under a variety of conditions: snow, ice, grass, flat surfaces, irregular surfaces and so on. The shape is also efficient at holding the bag thereon open to a maximum height. Finally, the device allows the use of a range of bag sizes and may be selected in fact based upon the size of bag which the purchaser is likely to desire to recycle.

Accordingly, the present invention provides a device for collecting and disposing of animal waste. The device includes a handle having an elongated shape and a loop that is joined to the handle at an oblique angle. The loop has a base and sides that generally define a trapezoid having rounded comers. A bag is removably attached to the loop. The bag is flexible and has an open end and a closed end. Commonly received bags which may be used are newspaper bags and grocery bags, despite the great size variation therebetween. When installed the bag passes through an interior portion of the loop and is folded over an exterior portion of the loop so that an edge of the bag located adjacent its open end extends partway towards the closed end of the bag. The device includes a first clip that is attached to the handle for securing a smaller sized bag to the front of the pole. The device includes a second clip securing a gather of “excess bag” to the rear of the pole when using a larger size of plastic/poly bag.

In embodiments, the device may further include a knife edge, straight or serrated, on the flexible band across the bottom, thus allowing a cutting or cleaving of pet waste from the surface on which it rests. In embodiments, the device may further include plastic prongs downwards to the flexible band, providing easier manufacture and greater flexibility. In embodiments, the device may further include a “size rating” based upon the sizes of bags commonly received in the area of sale. Such size rating may be based upon physical bag dimensions, source of the bag (a given newspaper or store) or other methods.

The elongated handle may be of a variety of lengths from short to quite long, depending upon circumstances. In the best mode now contemplated for carrying out the invention, elongated handle is a pole, allowing use of the device without stooping. In embodiments, the elongated handle may be shorter, down to the minimal elongation necessary for one handed use of the device.

To prepare the device for use, the owner places a bag which they desire to recycle through the loop, securing it as needed by one or both clips on the handle. Excess material of the bag may be gathered at one or both clips. If use of the knife edge is desirable, the bag may not occlude that edge, or the bag may entirely cover all four edges of the generally trapezoidal loop.

To use the device on relatively flat surfaces, the pet owner places the base of the loop against the ground or surface adjacent to the waste material. Using a raking motion, the pet owner scoops the waste material into the bag through an opening that is generally defined by the loop. On more irregular surfaces, the user may safely utilize the rounded comers of the generally trapezoidal loop to achieve a deeper and narrower scoop. On ice or snow, the rounded corners or the knife edge of the flexible band may be used to actually gouge or dig into the matrix around the pet wastes.

When finished collecting pet waste, the user orients the device so that the opening faces upward and shakes the bag to urge the animal waste towards the closed end of the bag. The user unclips the disposable bag, pulls the bag through the interior of the loop so that all soiled areas are contained within the interior of the bag, and seals the open end of the bag using ties and the like. By using larger bags such as grocery bags, the owner may greatly ease the task of sanitarily closing the bag. The user may then discard the bag and its contents.

Summary in Language of Claims

It is therefore one aspect, embodiment, objective and advantage of the present invention to provide a device for collecting and disposing of animal waste comprising: a handle having an elongated shape; a loop connected to the handle at an oblique angle, the loop having a base, a top and two sides that define a generally trapezoidal shape, the loop having rounded comers, wherein the two sides comprise plastic and the base comprises a flexible metal band; a bag removably attached to the loop, the bag being flexible and having an open end and a closed end, the bag passing through an interior portion of the loop and being folded over an exterior portion of the loop so that an edge of the bag located adjacent to the open end of the bag extends towards the closed end of the bag; and a first clip attached to the handle for securing the bag to the device.

It is therefore one aspect, embodiment, objective and advantage of the present invention to provide a device further comprising: a plurality of fasteners connecting the flexible band to the two sides, each fastener selected from the group consisting of: bolts, screws, nails, rivets, snaps, adhesives, and combinations thereof.

It is therefore one aspect, embodiment, objective and advantage of the present invention to provide a device wherein the flexible band is embedded into the two sides, whereby it is fastened thereto.

It is therefore one aspect, embodiment, objective and advantage of the present invention to provide a device for collecting and disposing of animal waste comprising: an elongated handle; a loop connected to the handle at an oblique angle, the loop comprising a generally trapezoidal shape, the loop having at least one knife edge; a flexible bag removably attached to the loop and passing through the loop; and a first clip attached to the handle, the bag secured to the device by the first clip.

It is therefore one aspect, embodiment, objective and advantage of the present invention to provide a device wherein the knife edge further comprises: one member selected from the group consisting of: straight edges, serrated edges, and combinations thereof.

It is therefore one aspect, embodiment, objective and advantage of the present invention to provide a device for collecting and disposing of animal waste comprising: an elongated handle having a plurality of faces; a loop connected to the handle at an oblique angle; a flexible bag removably attached to and passing through the loop; and a plurality of clips attached to the handle on different faces thereof, whereby the flexible bag may be secured to the device by at least one clip and further whereby the flexible bag may be a non-optimal size for the device.

It is therefore one aspect, embodiment, objective and advantage of the present invention to provide a device for collecting and disposing of animal waste comprising: an elongated handle; a loop connected to the handle at an oblique angle, the loop comprising a generally trapezoidal shape; a flexible bag removably attached to the loop and passing through the loop; a first clip attached to the handle, the bag secured to the device by the first clip; and a size rating on the device, the size rating providing information regarding the optimum size of bag to use with the device.

It is therefore one aspect, embodiment, objective and advantage of the present invention to provide a device wherein the size rating further comprises: an indication of at least one source of the optimum size of bag to use with the device.

It is therefore one aspect, embodiment, objective and advantage of the present invention to provide a device wherein the indication of at least one source of the optimum size of bag to use with the device further comprises: an identification of one member selected from the group consisting of: local newspapers which wrap their newspaper in a bag, local grocery stores which provide grocery bags, local stores which provide bags at the time of purchase, and combinations thereof.

### BRIEF DESCRIPTION OF THE DRAWINGS

FIG. 1 is a front view of a device for collecting animal waste.

FIG. 2 is a side view of the device for collecting animal waste.

FIG. 3 is a side view of the device of FIGS. 1 and 2 with a disposable bag installed for collecting animal waste.

FIG. 4 is a frontal view of the device in a second embodiment having a construction of plastic prongs and a metallic band.

### DETAILED DESCRIPTION

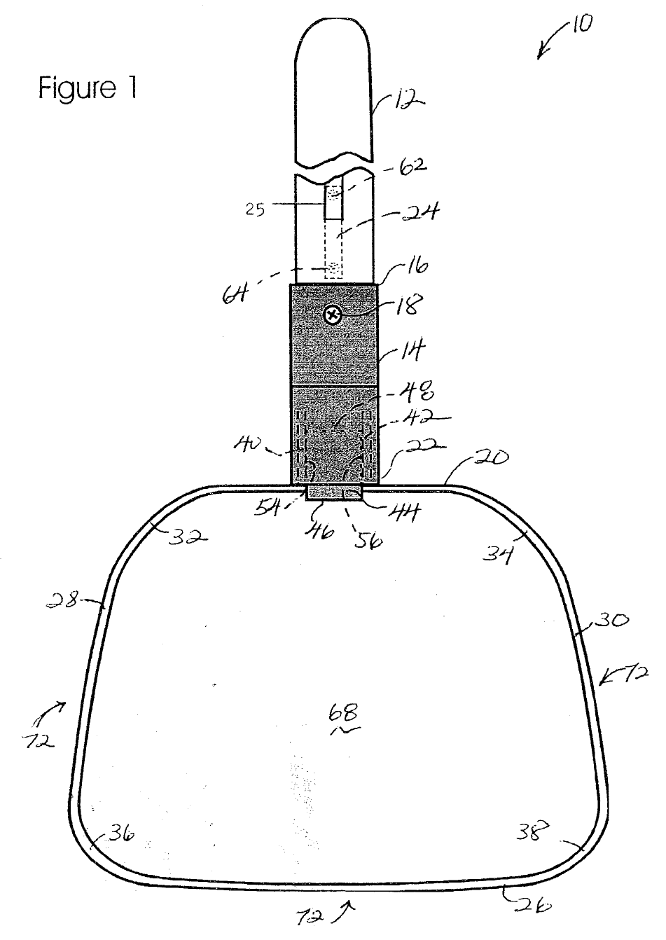

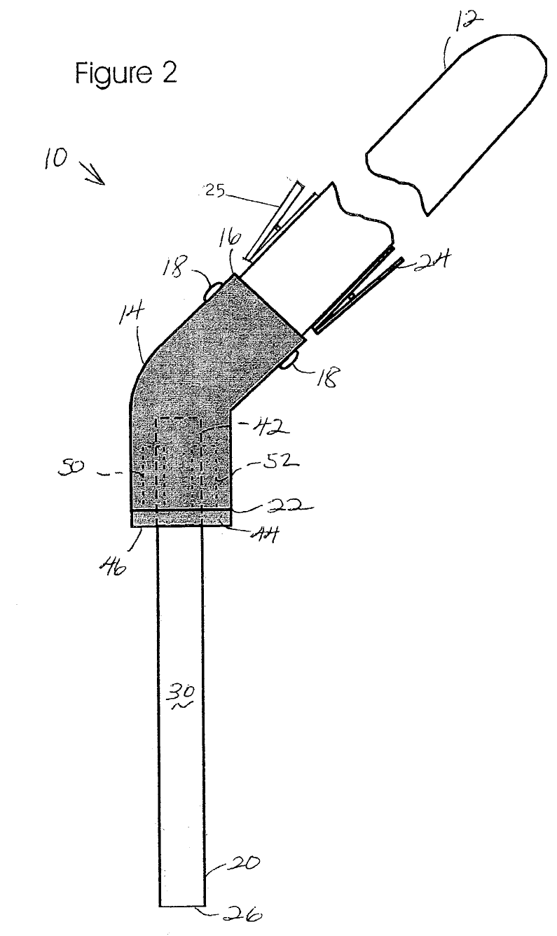

FIGS. 1 and 2 show, respectively, front and side views of a device 10 that a pet owner may use to collect fecal matter or other organic waste that a pet or other animal has deposited on the ground. The device 10 comprises a handle 12 of elongated shape (shown shortened so as to fit within the diagram but normally much longer) that is affixed to an angular joint 14. The handle 12 shown in FIGS. 1 and 2 is substantially rigid, has a generally circular cross-section, and may be solid or tubular. In other embodiments, the handle may have a non-circular cross-section or may be telescoping to aid in transporting the device 10 from place to place. The angular joint 14 includes a tubular elbow, which is bent at about a forty-five degree angle but may assume other orientations and angles. The handle 12 is inserted into a first end 16 of the tubular elbow 14 and is secured with an adhesive, screws 18, fasteners and the like.

The collection device 10 includes a loop 20 of generally trapezoidal shape that is connected to a second end 22 of the tubular elbow or angular joint 12, and a first clip 24 and a second clip 25 that are attached to the handle 12 adjacent to the first end 16 of the elbow 12. The loop is thus connected to the handle at an oblique angle. First clip 25 is hidden by the handle 12. Clips 24 and 25 may not necessarily be directly opposed: in embodiments, the position of these clips may change radially or by being moved up and down along the handle 12. In general, the first or second clip secures the bag to the device: the clips are for this purpose. In the embodiment shown in FIGS. 1 and 2, the loop 20 comprises a flexible, flat bar of aluminum having a generally trapezoidal shape with slightly curved base and top comprising flexible band 26 and two sides 28, 30, rounded comers 32, 34, 36, 38, and substantially parallel ends or prongs 40, 42. The prongs 40, 42 are inserted into the second end 14 of the tubular elbow 12 and are secured in place using a plug 44 that is wedged, glued, secured by screws or the like, in place between the prongs 40, 42. As shown in FIGS. 1 and 2, the plug 44 may include a cap portion 46 that abuts the second end 22 of the tubular elbow 14, and a barrel portion 48 that sits within the angular joint 14 between the prongs 40, 42. A plug of PVC, wood, plastic, or the like may be used. The barrel portion 48 includes walls having arcuate portions 50, 52 that conform to an inner radius of the tubular elbow 14, and substantially flat portions 54, 56 that rest against the prongs 40, 42. In the preferred embodiment, the loop 20 comprises a single flexible band or bar of metal. In other embodiments, the loop may comprise a multipart structure or a different material such as plastic. In yet other embodiments, the handle and loop may comprise a single piece.

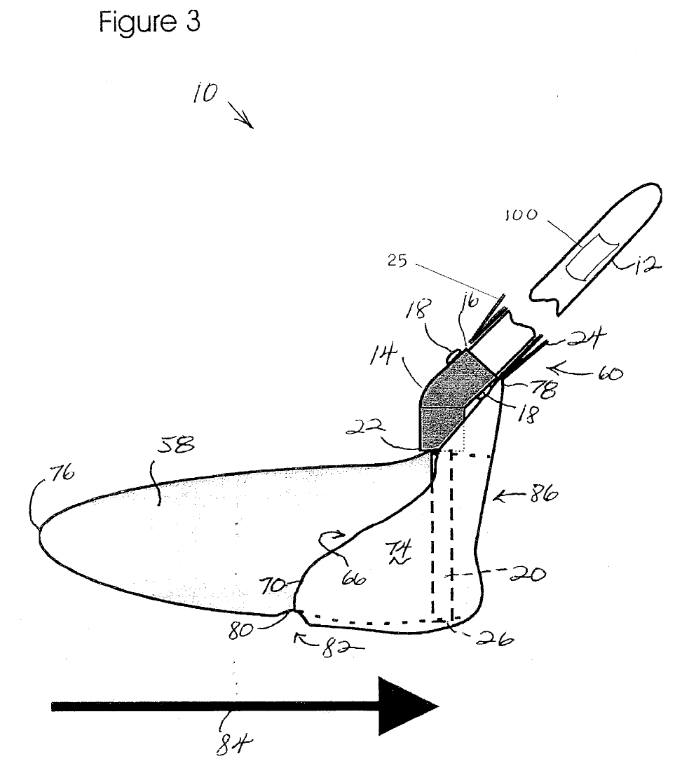

Turning now to FIG. 3, which shows a side view of the device 10 with a disposable bag 58 installed for collecting animal waste. The bag 58 is held in place with the clip 24 that is attached to an underside 60 of the handle 12 adjacent to the first end 16 of the angular joint 14. The clip 24 shown in FIGS. 1-3 is held in place with a pair of screws 62, 64, but may be affixed to the handle 12 using other techniques including riveting, banding, gluing, etc. Although any disposable bag 58 may be employed, particularly useful disposable bags 58 include standard plastic newspaper bags, which in some areas are nominally about nine inches wide by about twenty-three inches long when laid flat. The issue of bag sizes will be discussed at greater length below.

The bag 58 is flexible so that it can be installed by inserting an open end 66 of the bag 58 through an interior 68 of the loop 20 and subsequently folding an edge 70 adjacent to the open end 66 of the bag 58 back over an outer portion 72 of the loop 20. The resulting apron 74 covers the base 26 and sides 28, 30 of the loop 20 and extends beyond the loop 20 partway towards a closed end 76 of the disposable bag 58. A top edge 78 of the open end 66 of the bag 58 is positioned within the clip 24 to keep the bag 58 open during collection of waste. In addition, clipping the top edge 78 of the bag 58 forms a constriction 80 between the ends 66, 76 of the bag 58. During use, the constriction 80 helps retain waste material in the bag 58 and provides a clearance between the ground and a region 82 of the disposable bag 58 adjacent to the open end 66. By this means, the bag is removably attached to the loop, passing through the interior portion of the loop and being folded over the exterior portion of the loop so that an edge of the bag adjacent to the open end of the bag extends towards the closed end of the bag.

Alternatively, the device may be utilized with large grocery sized plastic bags, which are wider and have more material. Such bags may be secured by having the mouth of the bag pulled substantially around the loop and handle and the excess material of the mouth gathered and secured at clip 25. In yet an alternative usage embodiment, a larger bag may have the mouth held at clip 24, while material taken from the back side of the loop (that is, from the body of the bag rather than the mouth thereof) may be gathered and/or secured at clip 25. It will be appreciated that the usage of two clips on opposite sides of the handle provides not redundancy but rather the ability to recycle a wide range bag sizes and shapes. By the use of two clips, quite large bags may be successfully used. Testing has revealed that even standard sized garbage bags (size rated in tens of gallons) may be used if two clips are employed on a device sized for a local newspaper's plastic bag of the aforementioned 9 inch by 23 inch size. Thus the invention is most emphatically not limited to a single bag size: while an optimal size bag is one having a mouth circumference approximately equal to or slightly greater in circumference than the loop, bags of much larger size may be used.

Most generally, a plurality of clips and equivalents are attached to the handle on different faces thereof, whereby the flexible bag may be secured to the device by at least one clip and further whereby the flexible bag may be a non-optimal size for the device.

However, knowing the optimal size of bag to use with the device would be greatly beneficial to the user. Yet another useful feature of the invention is size rating 100 shown on the device in FIG. 3. Size rating 100 may be words or numbers incised onto handle 12, a decal on the handle, markings or similar communication. The size rating provides information regarding the optimum size of bag to use with the device. This size rating 100 allows the user and most particularly a potential purchaser to determine easily what sizes of bag work well with the invention. As the discussion above made clear, it is very easy to use a “newspaper” bag of the exactly correct size and shape: a single clip may advantageously be utilized for securing the bag to the handle of the device. In order to determine the correct size of bag, users/purchasers may consult the size rating. This size rating may be provided in standard units of linear measure, or alternatively, it may in embodiments identify/indicate at least one source(s) of the optimum size of bag to use with the device: the bags which most advantageously fit the device. Thus, size rating 100 may identify a particular local newspaper as being the source of bags which most easily fit with and may be recycled by use of the device of the present invention. In yet further sub-embodiments, size rating 100 may be altered depending upon locality or date of sale to specifically identify local stores, newspapers, etc. In other further sub-embodiments, the device may be provided/sold in a range of sizes selected so as to match various local sources. For example, in the Colorado Front Range Area, the device may be supplied in three decreasing sizes: 1) “Sunday Supplement”, 2) “Denver Post or Rocky Mountain News”, or 3) “Boulder Daily Camera”. Potential purchasers could then select the optimal size which allows them to easily reuse the bags wrapped around their own chosen newspaper, local grocery stores which provide grocery bags, local stores which provide bags at the time of purchase, and combinations thereof. In general, a bag of optimal size for the device is one in which the mouth of the bag is of approximately equal or slightly greater circumference than the circumference of the loop. In yet further embodiments the device may omit one clip, reducing flexibility of use and relying upon user's securing the optimal size of bag only.

To use the device 10, the pet owner places the base 26 of the loop 20 against the ground adjacent to the waste material. Using a raking motion shown by an arrow 84 in FIG. 3, the pet owner scoops the waste material into the disposable bag 58 through an opening 86 that is generally defined by the loop 20. On irregular or broken ground, the rounded comers of the device are advantageous in allowing a much smaller scoop to go deeper into small depressions in the ground surface. When the pet waste material is unfortunately intermixed with grass, manmade fiber surfaces or something else, those embodiments offering a knife edge on flexible band 26 may be used to scrape or even cut the material loose. In particular, pet waste which is initially deposited upon snow or ice tends to melt into the snow/ice and then freeze, presenting owners with a problem the present device helps them solve: the knife edge on flexible band 26 and the rounded comers of trapezoidal opening 68 provide means to scrape/dig the item free and secure it within the bag. Sharp comers, such as 90 degree angle comers, are less desirable as they gouge lawn/grass or other surfaces and are prone to breaking. Non-flexible embodiments of flexible band 26 are not presently desired as they do not allow the base 72 to adapt to the surface being cleaned. At the present time, the presently preferred embodiment and best mode now contemplated use a flexible band having a Young's Modulus, modulus of elasticity or springiness equivalent to “strapping tape”, the metal band material used in construction, preferably the type without a sequence of holes through the metal.

The process may be repeated in other areas until all of the animal waste has been collected or until the disposable bag 58 is full. When finished collecting animal waste, the user orients the device 10 so that the opening 86 faces upward and shakes the bag 58 to urge the animal waste towards the closed end 76 of the disposable bag 58. The user then unclips the disposable bag 58, pulls the bag through the interior 68 of the loop 20 so that all soiled areas are contained within the interior of the disposable bag 58, and seals the open end 66 of the bag 58 using ties and the like. The user may then discard the bag 58 and its contents.

One should appreciate that during collection, the bag covers 58 the loop 20 so that little or no pet waste contacts the loop 20, which reduces the need for cleaning the device 10. Additionally, the constriction 80 provides a clearance between the edge 70 of the bag 58 and the ground, which reduces the chance of soiling the bag 58 near its edge 70 and minimizes any user contact with animal waste during removal and sealing of the bag 58.

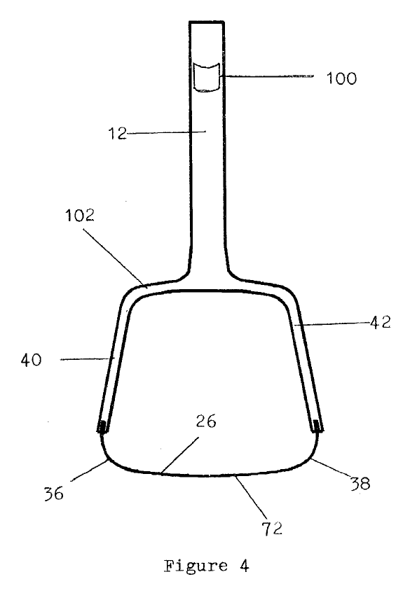

FIG. 4 an alternative embodiment of the invention in which prongs 40 and 42 may be of plastic while flexible band 26 may be of flexible metal. The generally trapezoidal shape having rounded comers 36, 38 is used. Base 72 is slightly curved for more efficient pickup. Top 102 of the loop is generally straight, and while in the second embodiment shown in FIG. 4 is a unitary body with handle 12, top 102 and prongs 40 and 42 need not be unitary with handle 12. Size rating 100 is utilized in this embodiment. A plurality of fasteners connect the flexible band to the two sides: the fasteners may be selected from the group consisting of bolts, screws, nails, rivets, snaps, adhesives and combinations thereof. In the embodiment shown in FIG. 4, the flexible band is embedded into the two sides, whereby it is fastened thereto. A first end of the flexible band is embedded into a first prong, a second end of the flexible band is embedded into a second prong.

This embodiment and others may incorporate a knife edge on the flexible band. Such a knife edge (straight or serrated) may be used to facilitate scraping or cutting of waste loose from any fibrous matrix in which it may become embedded. In addition, such a knife edge may facilitate the use of the rounded comers of a trapezoidal loop in digging in ice and snow. In addition, even under normal circumstances, or on regular or flat surfaces and even the very flattest of surfaces, the knife edge embodiment may provide a faster, more efficient clean up of the waste. In particular, the combination of the flexible band and a straight knife blade aids pickup on regular or flat surfaces. The knife blade may be one edge of the band, may be both edges, may extend the length of the base or only partially the length of the base, may extend up the loop to non-base portions thereof, may be as wide as the loop or very narrow in comparison to the width of the loop and may have any of a variety of serrations.

The flexible band may be attached to the prongs by any of a variety of fasteners: bolts, screws, nails, rivets, snaps, adhesives, or as shown in FIG. 4, it may be embedded in the material of prongs 40, 42.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A device for collecting and disposing of animal waste comprising:
a handle having an elongated shape;
a loop connected to the handle at an oblique angle, the loop having a base, a top and two sides that define a generally trapezoidal shape, the loop having rounded comers, wherein the two sides comprise plastic and the base comprises a flexible metal band;
a bag removably attached to the loop, the bag being flexible and having an open end and a closed end, the bag passing through an interior portion of the loop and being folded over an exterior portion of the loop so that an edge of the bag located adjacent to the open end of the bag extends towards the closed end of the bag; and
a first clip attached to the handle for securing the bag to the device.

2. The device of claim 1, further comprising:
a plurality of fasteners connecting the flexible band to the two sides, each fastener selected from the group consisting of: bolts, screws, nails, rivets, snaps, adhesives, and combinations thereof.

3. The device of claim 1, wherein the flexible band is embedded into the two sides, whereby it is fastened thereto.

4. A device for collecting and disposing of animal waste comprising:
an elongated handle;
a loop connected to the handle at an oblique angle, the loop comprising a generally trapezoidal shape, the loop having at least one knife edge;
a flexible bag removably attached to the loop and passing through the loop; and
a first clip attached to the handle, the bag secured to the device by the first clip.

5. The device of claim 4, wherein the knife edge further comprises:
one member selected from the group consisting of: straight edges, serrated edges, and combinations thereof.

6. A device for collecting and disposing of animal waste comprising:
an elongated handle having a plurality of faces;
a loop connected to the handle at an oblique angle;
a flexible bag removably attached to and passing through the loop; and
a plurality of clips attached to the handle on different faces thereof, whereby the flexible bag may be secured to the device by at least one clip and further whereby the flexible bag may be a non-optimal size for the device.

7. A device for collecting and disposing of animal waste comprising:
an elongated handle;
a loop connected to the handle at an oblique angle, the loop comprising a generally trapezoidal shape;
a flexible bag removably attached to the loop and passing through the loop;
a first clip attached to the handle, the bag secured to the device by the first clip; and
a size rating on the device, the size rating providing information regarding the optimum size of bag to use with the device.

8. The device of claim 7, wherein the size rating further comprises:
an indication of at least one source of the optimum size of bag to use with the device.

9. The device of claim 8, wherein the indication of at least one source of the optimum size of bag to use with the device further comprises:
an identification of one member selected from the group consisting of: local newspapers which wrap their newspaper in a bag, local grocery stores which provide grocery bags, local stores which provide bags at the time of purchase, and combinations thereof.
